(19) United States
(12) Patent Application Publication
(10) Pub. No.: US 2024/0257797 A1
(43) Pub. Date: Aug. 1, 2024

(54) METHOD OF SOUND PROCESSING SIMULATING THE ACOUSTICS OF ANCIENT THEATRE

(71) Applicant: Piotr WOJDYLLO, Warszawa (PL)

(72) Inventor: Piotr WOJDYLLO, Warszawa (PL)

(21) Appl. No.: 18/578,704

(22) PCT Filed: Jul. 14, 2022
(86) PCT No.: PCT/PL2022/000041

§ 371 Date: Jan. 11, 2024

(51) Int. Cl. G10K 15/08

(52) U.S. Cl. CPC G10K 15/08

(57) ABSTRACT

The method of sound processing according to the invention takes into account the quantum effect of the propagation of the sound in the material from which the theatre walls are built, what allows to reconstruct the timbre of the processed sound. The sound processed with the method according to the invention is clearer, deeper and stronger than the original. The method consists in the digital filtering of the sound with the aid of finite impulse response obtained from pairs of signals delay-attenuation computed for the trajectories originating from the sound source and composed from the trajectory segments in the air and in the material of theatre walls. The method thereof is characterized by the fact that the first directions of the trajectory segments in the air are selected randomly and the next ones are determined according to the rule that the reflection angle from the theatre wall is the same as the incidence angle till the moment when the trajectory reaches the listener's location. In the advantageous embodiments of the invention the material from which the theatre walls are built is wood with the density 400 kg/m3 and with the sound propagation speed 4000 m/s, the theatre building is equipped with the stage and the wall behind the stage, the source of sound propagation are the actor's lips where the mentioned actor is on the stage or in the middle of orchestra and the listener sits in the middle of the first row.

The subject of invention is the method of sound processing simulating the acoustics of antique theatre with the goal to present the esthetic valours of antique theatre acoustics.

### PRIOR ART

The known solution from the publication Nico F. Declercq and Cindy S. A. Dekeyser, “Acoustic diffraction effects at the Hellenistic amphitheater of Epidaurus: Seat rows responsible for the marvelous acoustics” The Journal of the Acoustical Society of America 121, 2011 (2007) analyzes only the impact of the antique theatre for the specific frequencies and does not take into account the delays. Moreover, it relates to the preserved parts of the theatre but does not take into account these ones that were designed and in use but have not been preserved till our times.

The known solution from the publication Constant Hak, Niels Hoekstra, Bareld Nicolai, Remy Wenmaekers, “Project Ancient Acoustics part 1 of 4: A method for accurate impulse response measurements in large open air theatres.” 23rd International Congress on Sound and Vibration, Athens, Greece (2016) is based on the measurements of the impulse responses, which however are erroneous due to the noise and the measurement conditions.

The known solution from the patent PL 223995 relates to the acoustic ray tracing and leads to finding the impulse response of the interior of the theatre.

Using the impulse response the input signal is filtered.

The known solutions except PL 223995 do not take into account quantum effects in the simulation of antique theatre acoustics. Patent PL 223995 applies also random trajectories in the air that results in the undesired effect when the not too numerous trajectories are produced.

The ‘component’ is a substance that is homogenous with respect to the density and the sound velocity. The ‘walls’ are acoustic objects composed from one or more components from which the theatre building is constructed.

### SUMMARY OF THE INVENTION

Method of sound processing simulating the acoustics of antique theatre according to the invention comprising of digital filtering of the sound by means of the finite impulse response resulting from the signal pairs delay/attenuation calculated for trajectories starting in the sound source composed from the segments in air and in the material of theatre walls having the direction of the first segment in the air selected randomly and the next ones selected by the rule that the angle of reflection from the theatre wall is equal to the angle of incidence till the trajectory reaches the location of the listener, while all the directions of the trajectory segments in the components of the walls are selected randomly.

Accordingly, in a further embodiment of the method according to the invention, the walls of the theatre are composed from wood with density 400 kg/m3 and the sound velocity 4000 m/s, the theatre building includes the stage and the wall behind the stage, the sound source are the actor's lips positioned on the stage or in the centre of the orchestra and the listener is located in the middle of the first row.

The sound processed according to the invention is cleaner, deeper and stronger than the original. Also introduces the impression of the space surrounding the listener. Particularly, it relates to the soloist's voice and the sound of the accompanying instrument, if in the recording the sound was transmitted to the closely positioned microphone.

The method of sound processing takes into account the quantum effect of sound propagation in the wall allowing to reconstruct the timbre of the processed sound. The sound propagation in the air follows the rules of the geometrical acoustics. This is a preferred result in comparison with the solution proposed in PL 223995, because if we select the directions of the trajectory segments randomly, the processed sound becomes darker and attenuated.

### PREFERRED EMBODIMENT

The preferred embodiment of the invention is the application of the method according to the invention to the recorded sound of the actor singing to the microphone which is digitally sampled with the frequency 44100 Hz and the resolution 16 bits mono. In the singing we introduce modification by means of the digital filtering. To obtain the finite impulse response with which we will filter the signal, we generate trajectories from the initial point to the end point crossing the air and the theatre walls. The segments coming from the source and crossing the air have directions selected randomly. The segments going through the theatre walls have directions selected randomly. The next except the first segments that cross the air are selected consistently with the rule that the angle of reflection is equal to the angle of incidence.

For every trajectory segment we find a pair of partial signals delay/attenuation Partial delay and attenuation is calculated based on density and sound velocity in the wall material or in the air: the delay is a quotient of a distance the sound travels in the component (material) over a sound velocity in this component, the attenuation F is given by the formula:

$$F = 1 + \frac{S \times N}{V \times {D}^{1 / 3}} \qquad ( 1 )$$

where:
N—number of samples in a second in the sound that is to be processed
V—a sound velocity in the component
S—a distance travelled by the sound in the component
D—a density of the component

In the preferred embodiment N=44100.

The theatre proportions are found according to the description from Vitruvius “The ten books on architecture” and the size of the theatre in Epidaurus. It should be mentioned that in Epidaurus the higher part of seats was added only in Roman times. Earlier there was a colonnade.

For the purpose of simulation the material from which the theatre was built was wood with density 400 kg/m3 and velocity of sound 4000 m/s.

The light wood (pine, fir, spruce) has a density of 400-500 kg/m3 and the respective sound velocity is 4000-5000 m/s The choice of density 400 kg/m3 and the sound velocity 4000 kg/m3 is a good representation of the true material.

The theatre building should be completed with the stage and the wall behind the stage which are missing in Epidaurus.

The simulation is performed thus that the recorded voice of the performer is assumed to propagate from the initial point which are the actor's lips standing on the middle of the stage edge to the endpoint which are the listener's ears sitting in the middle of the first row. From the initial point we generate the trajectories composed of the segments of sound propagation in air and of the segments of sound propagation in the material of the walls. The partial attenuation is found by formula (1). Then we add the partial delays and we multiply the partial attenuations so we obtain the pair of signals delay/attenuation for the trajectory. We continue generating the trajectories till adding the parameters of the new trajectory does not change values of the impulse response by more than 1%.

The sound source is located on the actor's lips, the actor standing on the middle of the stage edge. The sound receiver is located at the height of the listener's ears, the listener-sitting in the middle of the first row.

The simulation should take into account that the sound perception is impacted by the ears' location, namely Head Related Transfer Function.

For each trajectory we find the pair of signals delay/attenuation that are later aggregated if the delays coincide. Thus we obtain the impulse response, with which the input signal is filtered to simulate the acoustics of the ancient theatre.

The expert can easily modify the algorithm for a different location of the source on the stage or a different location of the receiver on the seats. The useful modification is to place the sound source in the orchestra where the choral parts were performed from.

To better understand the invention it should be mentioned that the preserved till our times stone theatres were equipped with the resonator vases. The vases described by Vitruvius were tuned consistently with the then used musical scales. The wooden theatres by Vitruvius description did not require such an equipment.

Further, Vitruvius describes two kinds of theatres: so-called Greek and so-called Roman. The Greek theatre was destined for the musical performance and the actors perform on the stage and on the orchestra. Hence, to find an impulse response it is better to simulate the Greek theatre.

1. The method of sound processing simulating the acoustics of the ancient theatre consisting in the digital filtering using the finite impulse response obtained from pairs of signals delay-attenuation computed for the segments of trajectories in the theatre wall materials, whose directions are selected randomly comprising of that directions of first sound trajectory segments in the air are selected randomly and the directions of the next segments are determined by the rule that the reflection angle at the theatre wall is equal to angle of incidence until the moment when the trajectory achieves the listener's location.

2. The method of sound processing according to claim 1 comprising of that the material from which the theatre walls are built is wood.

3. The method of sound processing according to claim 2 comprising of that wood has density 400-500 kg/m3 and the sound velocity therein is 4000-5000 m/s.

4. The method of sound processing according to claim 1 comprising of that the theatre building is equipped with a stage and a wall behind the stage.

5. The method of sound processing according to claim 1 comprising of that the source of sound propagation are the actor's lips while the actor is on the stage or in the middle of orchestra.

6. The method of sound processing according to claim 1 comprising of that the listener is located in the middle of the first row.
